(19) United States
(12) Patent Application Publication
(10) Pub. No.: US 2024/0244373 A1
(43) Pub. Date: Jul. 18, 2024

(54) SOUND PICKUP DEVICE

(71) Applicant: SONY GROUP CORPORATION, TOKYO (JP)

(72) Inventors: YUKIO HIRAMOTO, TOKYO (JP); RYUTARO WATANABE, TOKYO (JP)

(21) Appl. No.: 18/563,880

(22) PCT Filed: Feb. 22, 2022
(86) PCT No.: PCT/JP2022/007353

§ 371 Date: Nov. 23, 2023

(30) Foreign Application Priority Data
Jun. 14, 2021 (JP) 2021-099007

(51) Int. Cl. H04R 5/033; H04R 1/08; H04R 1/10

(52) U.S. Cl. CPC H04R 5/0335; H04R 1/083; H04R 1/1016; H04R 2460/09

(57) ABSTRACT

A sound pickup device includes: a sound pickup unit to which a sound is input; an attachment portion to which the sound pickup unit is attached and which is inserted into an ear canal; a holding portion that is inserted into the ear canal and holds the attachment portion at a predetermined position of the ear canal; a wearing portion positioned on an opposite side of the attachment portion with the holding portion interposed therebetween and formed in a shape having a curved portion; and an outer arrangement portion positioned on an opposite side of the holding portion with the wearing portion interposed therebetween and at least part of the outer arrangement portion positioned on an outer side of an auricle. The attachment portion, the holding portion, the wearing portion, and the outer arrangement portion each contain a linear material and are formed into a predetermined shape. The wearing portion is inserted into a cavum conchae and at least part of the wearing portion is engaged with the auricle.

### TECHNICAL FIELD

The present technology relates to a technical field of a sound pickup device used by being worn on an ear.

### BACKGROUND ART

In recent years, an ear-insertion type sound pickup device used by being worn on an ear has been widely used. As a recording method in the ear-insertion type sound pickup device, for example, there is binaural recording. Binaural recording is a method of recording a sound close to a sound in a state of reaching the eardrum of each user in consideration of individual differences such as the shape of the head, body, and auricle of each user.

When the binaural recorded sound is heard by an earphone or a headphone, it is possible to reproduce realistic feeling as if the user were present at the scene of the recording. Furthermore, a head-related transfer function (HRTF) expressing a change in sound generated according to the influence of diffraction or reflection by each part of the human body such as the head, the body, and the auricle for each user can be obtained on the basis of a binaural recorded sound signal. For example, by convolving the head-related transfer function with a sound signal reproduced from a normal sound source (dry source), it is possible to reproduce realistic feeling by virtually localizing a sound image.

Furthermore, as another application of the ear-insertion type sound pickup device, for example, noise canceling or the like may be performed in combination with a wearable sound output device such as an earphone and a headphone.

Various proposals have been made for a technology for performing binaural recording using the ear-insertion type sound pickup device (see, for example, Patent Document 1, Patent Document 2, Patent Document 3, and Patent Document 4).

### CITATION LIST

### Patent Document

Patent Document 1: Japanese Patent Application Laid-Open No. 2004-128854
Patent Document 2: Japanese Unexamined Patent Application Publication No. 2008-512015
Patent Document 3: WO 2020/021815 A
Patent Document 4: WO 2018/123252 A

### SUMMARY OF THE INVENTION

### Problems to be Solved by the Invention

By the way, in the ear-insertion type sound pickup device that performs binaural recording, it is necessary to satisfactorily input a sound to a sound pickup unit, and it is also necessary to ensure a favorable wearing state on an ear.

Therefore, an object of the present technology is to ensure a favorable wearing state on the ear while ensuring a favorable input state of a sound to the sound pickup unit.

### Solutions to Problems

First, a sound pickup device according to the present technology includes: a sound pickup unit to which a sound is input; an attachment portion to which the sound pickup unit is attached and which is inserted into an ear canal; a holding portion that is inserted into the ear canal and holds the attachment portion at a predetermined position of the ear canal; a wearing portion positioned on an opposite side of the attachment portion with the holding portion interposed therebetween and formed in a shape having a curved portion; and an outer arrangement portion positioned on an opposite side of the holding portion with the wearing portion interposed therebetween and at least part of the outer arrangement portion positioned on an outer side of the auricle. The attachment portion, the holding portion, the wearing portion, and the outer arrangement portion each contain a linear material and are formed into a predetermined shape. The wearing portion is inserted into the cavum conchae and at least part of the wearing portion is engaged with the auricle.

As a result, the attachment portion, the holding portion, and the wearing portion do not block the ear canal and have an acoustic transmission property, and the wearing portion is inserted into the cavum conchae and engaged with the auricle in a state where the sound pickup unit, the attachment portion, and the holding portion are inserted into the ear canal. Therefore, propagation of a sound wave toward the sound pickup unit is hardly inhibited, and the wearing portion formed in a shape having a curved portion is engaged with the auricle.

Second, in the sound pickup device according to the present technology described above, it is desirable that a device main body be constituted by the attachment portion, the holding portion, the wearing portion, and the outer arrangement portion, and the device main body contains one continuous linear material.

As a result, the device main body contains one member.

Third, in the sound pickup device according to the present technology described above, it is desirable that an end portion of the outer arrangement portion positioned on an opposite side of the wearing portion be provided as a terminal portion, and the terminal portion be formed in an annular shape.

As a result, the distal end of the terminal portion does not exist at a protruding position.

Fourth, in the sound pickup device according to the present technology described above, it is desirable that an end portion of the outer arrangement portion on the wearing portion side be provided as a base end portion having a curved shape, and the base end portion be in contact with the auricle.

As a result, it becomes difficult to change the position of the wearing portion in the cavum conchae.

Fifth, in the sound pickup device according to the present technology described above, it is desirable that a connection cord configured to output at least a signal be connected to the sound pickup unit, and the connection cord be wound around the outer arrangement portion.

As a result, the connection cord does not become an obstacle in a use state of the sound pickup device.

Sixth, in the sound pickup device according to the present technology described above, it is desirable that the wearing portion be formed in a circular shape.

As a result, versatility is higher than a case where the wearing portion is formed in another shape, and the wearing portion can be engaged with the auricle regardless of the size of the auricle.

Seventh, in the sound pickup device according to the present technology described above, it is desirable that the wearing portion be formed in an arc shape.

As a result, it becomes difficult for an earphone to interfere with the wearing portion in a state where the earphone is worn on the ear.

Eighth, in the sound pickup device according to the present technology described above, it is desirable that the holding portion be formed in a coil shape.

As a result, when the holding portion comes into contact with the auricle at the time of wearing the sound pickup device on the ear, the holding portion is easily deformed.

Ninth, in the sound pickup device according to the present technology described above, it is desirable that the holding portion be brought into contact with a wall surface forming the ear canal.

As a result, the sound pickup device is worn on the ear in a state where the holding portion is in contact with the wall surface.

Tenth, in the sound pickup device according to the present technology described above, it is desirable that at least part of the holding portion be formed linearly.

As a result, an occupied area of the holding portion between the wearing portion and the attachment portion becomes small, and a space between the wearing portion and the attachment portion becomes large.

Eleventh, in the sound pickup device according to the present technology described above, it is desirable that the attachment portion be formed in a coil shape.

As a result, a volume of the attachment portion is small, and reflection or diffraction of a sound wave by the attachment portion hardly occurs.

Twelfth, in the sound pickup device according to the present technology described above, it is desirable that the sound pickup unit be positioned inside the attachment portion.

As a result, the sound pickup unit does not come into contact with the wall surface forming the ear canal.

Thirteenth, in the sound pickup device according to the present technology described above, it is desirable that the sound pickup unit be attachable to and detachable from the attachment portion.

As a result, the sound pickup unit can be replaced with respect to the attachment portion.

Fourteenth, in the sound pickup device according to the present technology described above, it is desirable that the sound pickup unit be positioned in a state where a sound input hole is opened to an entrance side of the ear canal.

As a result, a sound input to the ear canal is reliably and smoothly input to the sound pickup unit.

### BRIEF DESCRIPTION OF DRAWINGS

FIG. 1 illustrates an embodiment of a sound pickup device of the present technology together with FIGS. 2 to 20, and is a perspective view of an ear on which the sound pickup device is worn.

FIG. 2 is a perspective view of the ear showing part of the ear in a partially sectional view.

FIG. 3 is an exploded perspective view of the sound pickup device.

FIG. 4 is a perspective view of the sound pickup device.

FIG. 5 is a side view of a device main body.

FIG. 6 is a plan view of the device main body.

FIG. 7 is a perspective view illustrating a portion inserted into the ear canal in a state where the sound pickup device is worn on the ear in a partially sectional view.

FIG. 8 is a view illustrating a state where the sound pickup device is worn on the ear.

FIG. 9 is a view illustrating a state where the sound pickup device is worn on the ear in a state where an earring is worn on the ear.

FIG. 10 is a view illustrating a state where the sound pickup device is worn on the ear in a state where a mask is worn on the face.

FIG. 11 illustrates another example of the sound pickup device together with FIGS. 12 to 14, and is an exploded perspective view of the sound pickup device.

FIG. 12 is a side view of the device main body.

FIG. 13 is a front view of the device main body.

FIG. 14 is a perspective view illustrating a positional relationship between the sound pickup device and an earphone.

FIG. 15 illustrates another example of the sound pickup device together with FIGS. 16 to 20, and is an exploded perspective view of the sound pickup device.

FIG. 16 is a side view of the device main body.

FIG. 17 is a front view of the device main body.

FIG. 18 is a perspective view illustrating a positional relationship between the sound pickup device and the earphone.

FIG. 19 is a perspective view illustrating a positional relationship between the sound pickup device and another earphone.

FIG. 20 is a perspective view illustrating a positional relationship between the sound pickup device and another earphone as viewed from a direction different from that in FIG. 19.

### MODE FOR CARRYING OUT THE INVENTION

Hereinafter, a mode for embodying the sound pickup device according to the present technology will be described with reference to the accompanying drawings.

### <Structure of Ear>

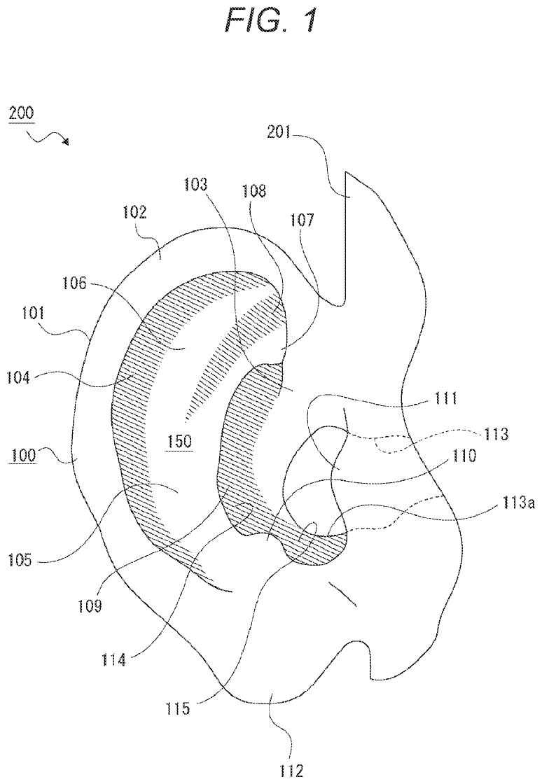

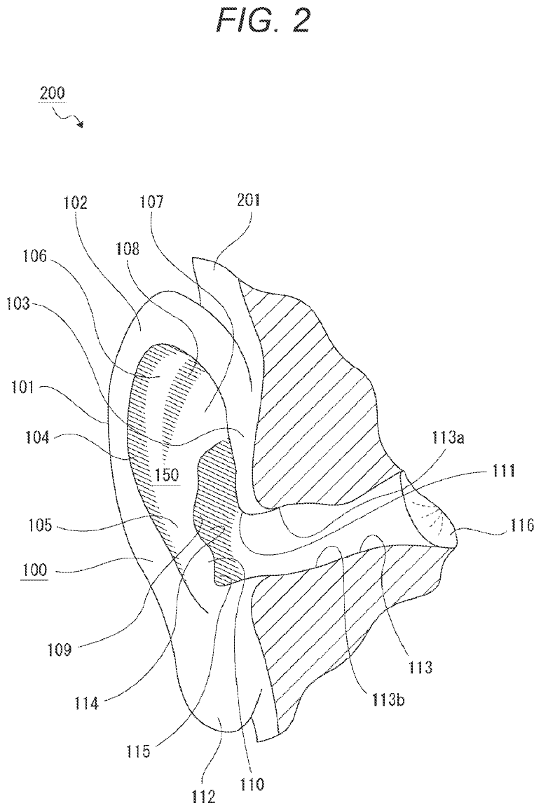

First, the structure of the ear on which the sound pickup device is worn will be described (see FIGS. 1 and 2).

The ears 100 and 100 are parts of a head 200, and include auricles 101 and 101 and respective parts such as an eardrum, a semicircular canal, and a cochlea which exist inside the head 200. The inner portions of the auricles 101 and 101 of the head 200 are temporal regions 201 and 201, respectively, and the auricles 101 and 101 protrude leftward or rightward from the temporal regions 201 and 201, respectively.

The auricle 101 has a shallow concave shape opened substantially forward as a whole so as to have an inner space 150, and has an outer peripheral portion having a portion called a helix 102 and a portion called a crus helicis 103 that is continuous to the helix 102 and positioned in the vicinity of the temporal region 201.

An inner portion of the helix 102 is referred to as a navicular fossa 104 having a concave shape, and a substantially lower half portion inside the navicular fossa 104 is referred to as an antihelix 105 having a convex shape. A bifurcated convex portion continuous to the antihelix 105 exists above the antihelix 105, and an outer portion and inner portion of the bifurcated portion are referred to as a superior crus of antihelix 106 and an inferior crus of antihelix 107, respectively. A portion between the superior crus of antihelix 106 and the inferior crus of antihelix 107 is referred to as a triangular fossa 108 having a concave shape, and a portion inside the antihelix 105 and the inferior crus of antihelix 107 is referred to as a cymba conchae 109 having a concave shape.

A portion that is continuous to the lower side of the antihelix 105 slightly bulges to the temporal region 201 side and is a portion called an antitragus 110. A portion on the temporal region 201 side facing the antitragus 110 is referred to as a tragus 111 slightly bulging to the antitragus 110 side, and a lower end portion that is continuous to the lower side of the helix 102 is referred to as an earlobe 112.

In a portion between the antitragus 110 and the tragus 111, an external acoustic opening 113a which is an entrance of the ear canal 113 exists, and the ear canal 113 communicates with the eardrum, the semicircular canal, and the like. In the inner space 150 of the auricle 101, a space surrounded by the antihelix 105, the inferior crus of antihelix 107, and the crus helicis 103, that is, a space in front of the cymba conchae 109, is referred to as a cavum conchae 114 and communicates with the external acoustic opening 113a of the ear canal 113. In the inner space 150, a space continuous to the lower side of the cavum conchae 114 and opened in a U shape is a space called an intertragic notch 115.

The ear canal 113 is a space surrounded by a wall surface 113b, and the eardrum 116 exists on the back side of the ear canal 113.

The inner space 150 of the auricle 101 includes a space near the cavum conchae 114, the intertragic notch 115, and the external acoustic opening 113a of the ear canal 113, and is a space also including a space in front of the navicular fossa 104, the antihelix 105, the superior crus of antihelix 106, the inferior crus of antihelix 107, the triangular fossa 108, the antitragus 110, and the tragus 111.

### <Configuration of Sound Pickup Device>

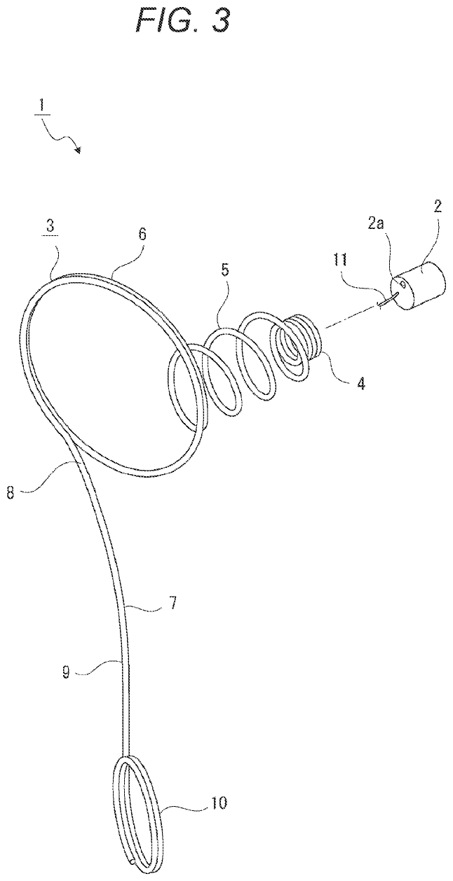

Next, configurations of sound pickup devices 1 and 1 will be described (see FIGS. 3 to 10). One of the sound pickup devices 1 and 1 is used for the left ear 100, and the other is used for the right ear 100. However, either one of the sound pickup devices 1 may be used.

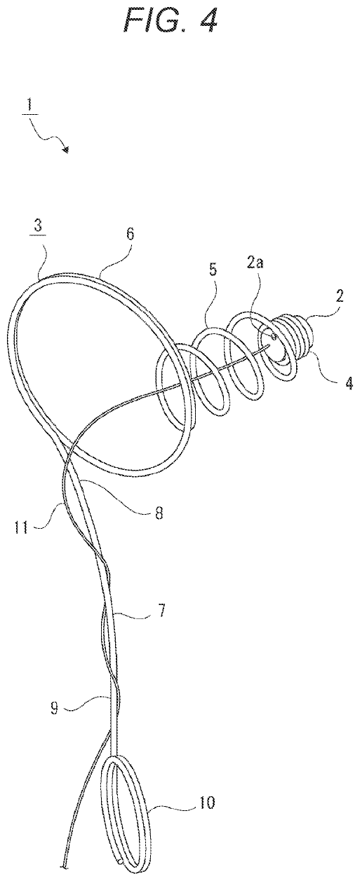

The sound pickup device 1 includes a sound pickup unit 2 that picks up a sound and a device main body 3 to which the sound pickup unit 2 is attached (see FIGS. 3 and 4).

The sound pickup unit 2 is, for example, a small microphone, and has a sound input hole 2a to which a sound is input. When a sound is input to the sound pickup unit 2 through the sound input hole 2a, for example, binaural recording is performed, and a head-related transfer function is measured on the basis of a recorded sound signal.

In the device main body 3, an attachment portion 4, a holding portion 5, a wearing portion 6, and an outer arrangement portion 7 are sequentially and continuously formed, and the attachment portion 4, the holding portion 5, the wearing portion 6, and the outer arrangement portion 7 each contain, for example, a linear (wire-like) metal material and are formed into a predetermined shape (see FIGS. 3 to 6). The material of the device main body 3 contains, for example, a so-called bare wire of stainless steel whose surface is not coated. Since the device main body contains an uncoated stainless bare wire, allergy is less likely to occur in a user when the sound pickup device 1 is worn on the ear 100, and the user can be protected.

In the device main body 3, for example, the attachment portion 4, the holding portion 5, the wearing portion 6, and the outer arrangement portion 7 are integrally formed. The device main body 3 has a cross-sectional shape formed in, for example, a circular shape. However, the cross-sectional shape of the device main body 3 is not limited to the circular shape, and an outer shape in the cross-sectional shape is preferably formed in a curved surface shape, for example, a circular shape, an elliptical shape, an oval shape, or the like from a viewpoint of preventing scratches when the device main body 3 comes into contact with the ear 100.

Since the device main body 3 contains a metal material, high durability can be ensured. However, as long as high durability can be ensured, the device main body 3 may contain a material other than the metal material such as a resin material, or may have such a configuration as that the surface of the metal material is covered with resin, rubber, or the like.

In addition, since the integral formation of the attachment portion 4, the holding portion 5, the wearing portion 6, and the outer arrangement portion 7 as described above eliminates the need for an operation of coupling the attachment portion 4 and the holding portion 5, the holding portion 5 and the wearing portion 6, and the wearing portion 6 and the outer arrangement portion 7, it is possible to reduce the number of components and reduce manufacturing cost in the sound pickup device 1. However, in the sound pickup device 1, at least one of the attachment portion 4, the holding portion 5, the wearing portion 6, or the outer arrangement portion 7 may be formed separately.

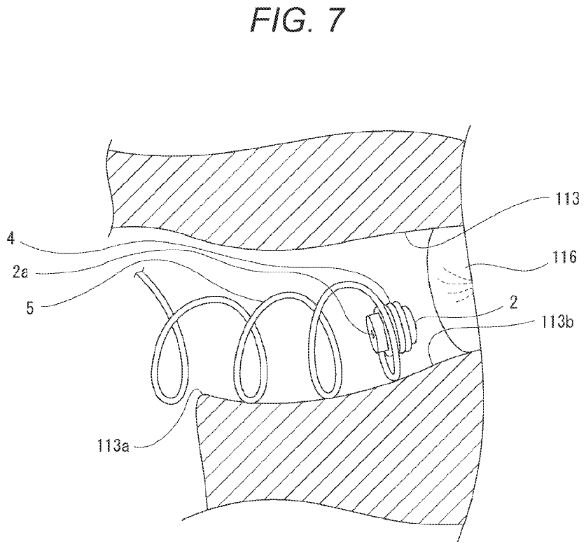

The attachment portion 4 is formed in a coil shape, has an outer shape of the same size in an axial direction, and has no gap in the axial direction, for example. The attachment portion 4 has a function of attaching the sound pickup unit 2, is inserted into the back side of the ear canal 113 together with the sound pickup unit 2, and is positioned in the vicinity of the eardrum 116 (see FIG. 7). The sound pickup unit 2 is attached to the inner side of the attachment portion 4 (see FIG. 4). The sound pickup unit 2 may be attached to the attachment portion 4 by, for example, adhesion or press fitting, or the sound pickup unit 2 may be detachably attached to the attachment portion 4.

Detachably attaching the sound pickup unit 2 to the attachment portion 4 makes the sound pickup unit 2 replaceable with respect to the attachment portion 4, so that the sound pickup unit 2 can always be kept clean and maintainability of the sound pickup unit 2 can be improved. In addition, detachably attaching the sound pickup unit 2 to the attachment portion 4 enables use of the sound pickup unit 2 of a type according to application.

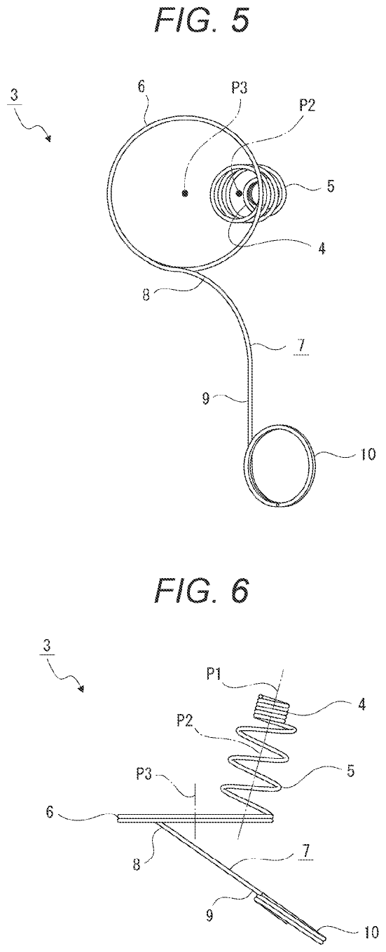

The holding portion 5 is formed in a coil shape whose outer diameter is larger than the outer diameter of the attachment portion 4, and is provided continuously to one end of the attachment portion 4 (see FIGS. 3 to 6). A central axis P2 of the holding portion 5 coincides with a central axis P1 of the attachment portion 4 (see FIG. 5). The central axis P2 of the holding portion 5 coincides with the central axis P1 of the attachment portion 4, whereby it is possible to ensure a stable weight balance in the device main body 3. However, the central axis P2 of the holding portion 5 and the central axis P1 of the attachment portion 4 do not necessarily need to coincide with each other, and the attachment portion 4 is only required to be positioned closer to the center of the ear canal 113 than the holding portion 5 is.

The holding portion 5 is in a state of having a gap in the axial direction, and has, for example, the same outer shape in the axial direction. The holding portion 5 has a function of holding the attachment portion 4 and the sound pickup unit 2 attached to the attachment portion 4, and is inserted into the ear canal 113 together with the attachment portion 4 (see FIG. 7).

The holding portion 5 is elastically deformable in a direction in which the central axis P2 is bent. Therefore, since the holding portion 5 can be inserted into the ear canal 113 while being slid and deformed on the wall surface 113b forming the ear canal 113, the sound pickup unit 2, the attachment portion 4, and the holding portion 5 can be smoothly and easily inserted into the ear canal 113.

In addition, since the outer diameter of the attachment portion 4 that holds the sound pickup unit 2 is smaller than the outer diameter of the holding portion 5, the attachment portion 4 is easily held in mid-air in the ear canal 113, the attachment portion 4 is hardly in contact with the wall surface 113b forming the ear canal 113, and the head-related transfer function of a sound input to the ear canal 113 by the sound pickup unit 2 can be accurately measured.

Furthermore, since the sound pickup unit 2 is attached to the inner side of the attachment portion 4 in a state where the attachment portion 4 and the holding portion 5 are inserted into the ear canal 113, the sound pickup unit 2 is held in mid-air in the ear canal 113.

Therefore, since the sound pickup unit 2 does not contact the wall surface 113b forming the ear canal 113, it is possible to more accurately measure the head-related transfer function determined by the sound input to the ear canal 113 by the sound pickup unit 2.

Furthermore, in a state where the attachment portion 4 and the holding portion 5 are inserted into the ear canal 113, the sound pickup unit 2 is positioned in a state where the sound input hole 2a is opened to the external acoustic opening 113a side. The external acoustic opening 113a is the entrance of the ear canal 113.

Therefore, since the sound input to the ear canal 113 is reliably and smoothly input to the sound pickup unit 2, it is possible to more accurately measure the head-related transfer function of the sound input to the ear canal 113.

In addition, since the holding portion 5 is formed in a coil shape in the sound pickup device 1, the sound pickup device 1 is easily deformed when the attachment portion 4 or the holding portion 5 comes into contact with the auricle 101 when the sound pickup device 1 is worn on the ear 100. Therefore, the sound pickup device 1 can be easily worn on the ear 100 in a state where a load on the ear 100 is reduced. In particular, since the holding portion 5 is easily deformed even when the holding portion 5 is inserted into the ear canal 113 and comes into contact with the wall surface 113b, the holding portion 5 can be inserted into the ear canal 113 satisfactorily and easily in a state where a load on the ear 100 is reduced.

In a state where the sound pickup device 1 is worn on the ear 100, the holding portion 5 is brought into contact with the wall surface 113b forming the ear canal 113 (see FIG. 7). As described above, since the sound pickup device 1 is worn on the ear 100 in a state where the holding portion 5 is in contact with the wall surface 113b, a stable wearing state of the sound pickup device 1 on the ear 100 can be ensured.

The wearing portion 6 is formed in, for example, a circular shape (see FIGS. 3 to 6). At least part of the wearing portion 6 is engaged with the auricle 101 in a state of being inserted into the cavum conchae 114. At least part of the wearing portion 6 is formed in a circular shape in a state where linear materials are overlapped in a double or more manner. By forming at least part of the wearing portion 6 in the state of being overlapped in the double or more manner as described above, the strength of the wearing portion 6 is increased, and a stable engagement state of the wearing portion 6 with the auricle 101 can be ensured. Note that the wearing portion 6 may be formed in a shape other than the circular shape, for example, a shape having a curved portion such as an elliptical shape and an oval shape.

The wearing portion 6 is formed in a circular shape whose outer diameter is larger than the outer diameter of the holding portion 5, and is provided continuously to one end of the holding portion 5. The wearing portion 6 is in a state where a central axis P3 is inclined with respect to the central axis P2 of the holding portion 5 (see FIGS. 5 and 6). The central axis P3 of the wearing portion 6 is inclined with respect to the central axis P2 of the holding portion 5, whereby the wearing portion 6 can be easily worn on the auricle 101, and the holding portion 5 can be easily inserted into the ear canal 113.

The wearing portion 6 is a portion engaged with part of the auricle 101, and has an outer diameter larger than the diameter of the external acoustic opening 113a in the ear canal 113.

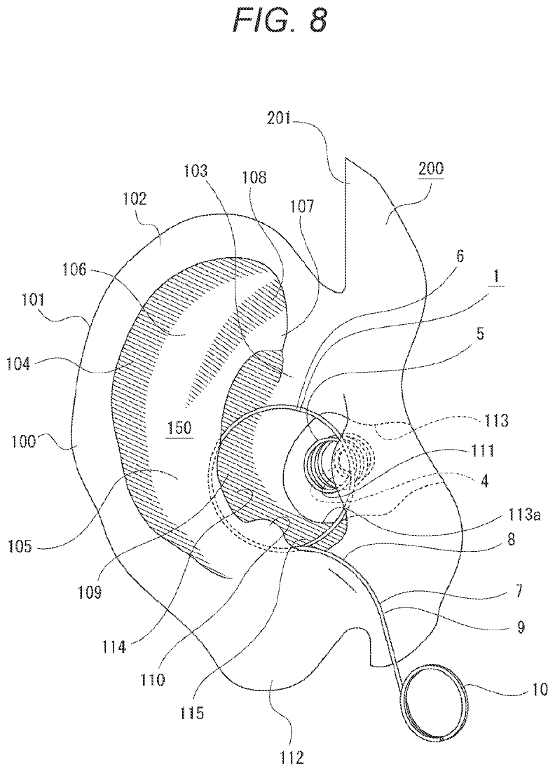

The wearing portion 6 is inserted into the cavum conchae 114 in a state where the sound pickup unit 2, the attachment portion 4, and the holding portion 5 are inserted into the ear canal 113 (see FIG. 8). In the wearing portion 6, at least part of the end surface on the attachment portion 4 side in the axial direction is brought into contact with the surface on the back side forming the cavum conchae 114, and each part is positioned on the inner surface side of the antitragus 110 and the inner surface side of the tragus 111. Note that at least part of the wearing portion 6 is in contact with the auricle 101 in a state of being inserted into the cavum conchae 114, but a contact position with the auricle 101 is changed depending on individual differences such as the size and shape of the auricle 101 of the user.

As described above, in the sound pickup device 1, the wearing portion 6 is formed in the circular shape, and at least part of the wearing portion 6 formed in the circular shape is engaged with the auricle 101. Therefore, since the wearing portion 6 is formed in the circular shape, versatility is higher than that in a case where the wearing portion 6 is formed in another shape, the wearing portion 6 can be engaged with the auricle 101 regardless of the size of the auricle 101, and a stable wearing state of the sound pickup device 1 on the ear 100 can be ensured regardless of the size of the auricle 101.

As described above, the central axis P3 of the wearing portion 6 and the central axis P2 of the holding portion 5 are in a relationship of being inclined to each other, whereby each of the attachment portion 4 and the holding portion 5 and the wearing portion 6 are in a positional relationship according to relative positions of the ear canal 113 and the cavum conchae 114.

Therefore, the attachment portion 4 and the holding portion 5 can be smoothly and easily inserted into the ear canal 113, and the wearing portion 6 can be smoothly and easily inserted into the cavum conchae 114 and worn on the auricle 101.

Furthermore, since the outer diameter of the wearing portion 6 is larger than the diameter of the external acoustic opening 113a of the ear canal 113, the wearing portion 6 is not inserted into the ear canal 113, a stable wearing state of the sound pickup device 1 on the ear 100 can be ensured, and the position of the sound pickup unit 2 with respect to the ear canal 113 can be stabilized.

In the outer arrangement portion 7, a base end portion 8, an intermediate portion 9, and a terminal portion 10 are formed sequentially and continuously from the wearing portion 6 side (see FIGS. 3 to 6).

The base end portion 8 is formed in a gentle curved shape and is provided continuously to one end of the wearing portion 6. The base end portion 8 is led out from the intertragic notch 115 to the front side of the auricle 101 in a state where the wearing portion 6 is positioned in the cavum conchae 114, and is positioned in a state of being in contact with the front portion of the lower end portion of the auricle 101 (see FIG. 8).

As described above, since the device main body 3 is worn on the ear 100 in a state where the base end portion 8 is in contact with the auricle 101, it is possible to ensure a stable wearing state of the sound pickup device 1 on the ear 100 without discomfort. In particular, since the base end portion 8 is led out from the intertragic notch 115 to the front side of the auricle 101 and is positioned in a state of being in contact with the front portion in the lower end portion of the auricle 101, it becomes difficult to change the position of the wearing portion 6 in the cavum conchae 114, and the position of the sound pickup unit 2 attached to the attachment portion 4 with respect to the ear canal 113 can be stabilized.

The intermediate portion 9 is formed linearly and is positioned from the lower end portion of the auricle 101 to the lower side of the auricle 101. However, the intermediate portion 9 may not be formed linearly.

The terminal portion 10 is formed in an annular shape whose axial direction is substantially the left-right direction, for example, a circular shape, and is positioned below the auricle 101 in a state where the wearing portion 6 is positioned in the cavum conchae 114. The terminal portion 10 is formed in a state where linear materials are overlapped in a double or more manner. In this manner, the strength of the terminal portion 10 is increased by forming the terminal portion 10 in a state of being overlapped in the double or more manner. In addition, the terminal portion 10 is formed in the annular shape, whereby the distal end of the terminal portion 10 does not exist at a protruding position, and it is possible to prevent the distal end of the terminal portion 10 from coming in contact with the user.

Note that the terminal portion 10 may be formed in a shape other than the circular shape, for example, an annular shape such as an elliptical shape and an oval shape. In addition, in a case where the terminal portion 10 is not formed in the annular shape, a distal end portion of the terminal portion 10 may be coated. By coating the distal end portion of the terminal portion 10, it is possible to protect the user when the user unintentionally touches the terminal portion 10.

As described above, since the sound pickup device 1 is worn on the ear 100 in the state where the wearing portion 6 is engaged with part of the auricle 101 in the state of being inserted into the cavum conchae 114 and the base end portion 8 of the outer arrangement portion 7 is in contact with the front portion of the lower end portion of the auricle 101, the sound pickup device 1 can be easily and stably worn on the ear 100.

In addition, since the sound pickup device 1 is worn on the ear 100 in the state where the wearing portion 6 is inserted into the cavum conchae 114, the sound pickup device 1 is less likely to fall off from the ear 100, and an easy and stable wearing state of the sound pickup device 1 on the ear 100 can be ensured.

In addition, since the sound pickup device 1 is configured such that the holding portion 5 and the attachment portion 4 protrude in the axial direction with respect to the wearing portion 6, the user can easily recognize that the holding portion 5 and the attachment portion 4 are portions to be inserted into the ear canal 113 as shapes, and the sound pickup device 1 can be easily worn on the ear 100.

Note that the sound pickup device 1 may have a configuration in which, among the outer arrangement portion 7, the base end portion 8 in contact with the front portion of the lower end portion of the auricle 101 is provided and the intermediate portion 9 and the terminal portion 10 are not provided. However, in this case, it is desirable that the distal end portion of the base end portion 8 be formed in the annular shape in order to prevent the distal end of the base end portion 8 from coming into contact with the user. However, in a case where the base end portion 8 is not formed in the annular shape, the distal end portion of the base end portion 8 may be coated. By coating the distal end portion of the base end portion 8, it is possible to protect the user when the user unintentionally touches the base end portion 8.

A connection cord 11 for outputting at least a signal is connected to the sound pickup unit 2 (see FIGS. 3 and 4). The connection cord 11 has a diameter of 1 mm or less, for example, about 0.6 mm.

In a state where the sound pickup device 1 is worn on the ear 100, the connection cord 11 is led out from the ear canal 113 to the outside of the auricle 101 through the inside of the holding portion 5 and the inside of the wearing portion 6. At this time, since the device main body 3 is provided with the outer arrangement portion 7 at least part of which is positioned outside the auricle 101, the connection cord 11 can be wound around the outer arrangement portion 7 (see FIG. 4).

Therefore, since the sound pickup device 1 is worn on the ear 100 in a state where the connection cord 11 is wound around the outer arrangement portion 7, the connection cord 11 does not interfere in a use state of the sound pickup device 1, and the usability of the sound pickup device 1 can be improved.

Note that, in a state where the sound pickup device 1 is worn on the ear 100, it is desirable to hold a portion of the connection cord 11 positioned below the outer arrangement portion 7 with, for example, a clip or the like (not illustrated) and attach the clip or the like to clothing or the like. By holding the connection cord 11 using the clip or the like in this manner, the connection cord 11 is less likely to be an obstacle in the use state of the sound pickup device 1, and the usability of the sound pickup device 1 can be further improved.

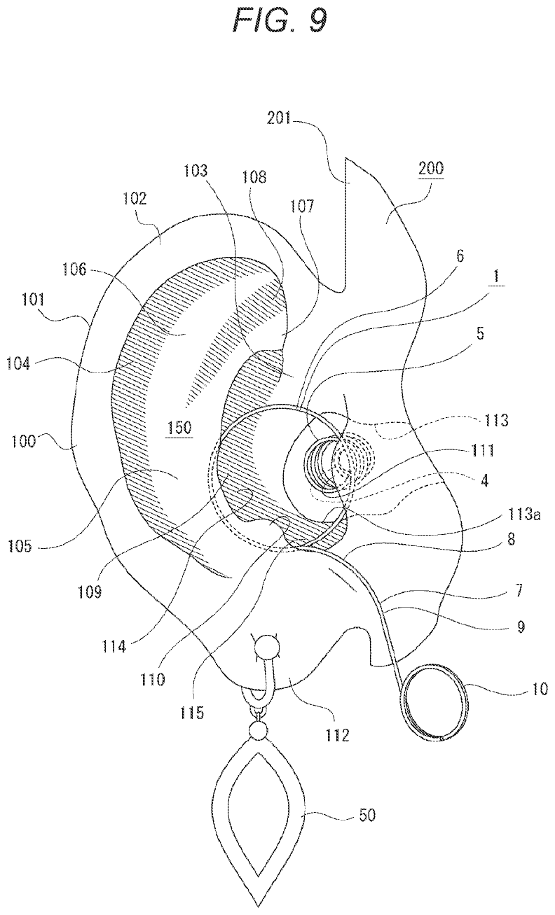

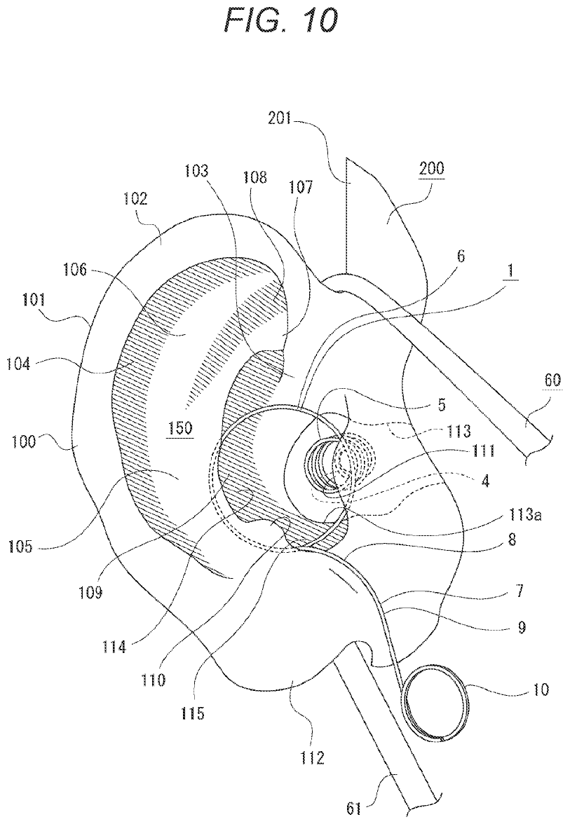

There is a case where the sound pickup device 1 is used in a state where the user wears an earring 50 on the ear 100, a state where the user wears a mask 60 on the face, or the like (see FIGS. 9 and 10).

In such a case, for example, in a state where the earring 50, a pierced earring, or the like is worn on the ear 100, the outer arrangement portion 7 is positioned closer to the temporal region 201 side than the earring 50, the pierced earing, or the like is (see FIG. 9). Therefore, the earring 50, the pierced earring, or the like does not interfere with the sound pickup device 1, and a stable wearing state of the sound pickup device 1 can be ensured.

Furthermore, for example, in a state where the mask 60 is worn on the face, the outer arrangement portion 7 is positioned between ear hook portions 61 of the mask 60 (see FIG. 10). Therefore, the mask 60 does not interfere with the sound pickup device 1, and a stable wearing state of the sound pickup device 1 can be ensured.

Furthermore, for example, although illustration is omitted, in a state where glasses are worn on the face, the entire sound pickup device 1 is positioned below an ear hook portion of the glasses, so that the glasses do not interfere with the sound pickup device 1, and a stable wearing state of the sound pickup device 1 can be ensured.

### SUMMARY

As described above, the sound pickup device 1 includes the attachment portion 4 to which the sound pickup unit 2 is attached and which is inserted into the ear canal 113, the holding portion 5 which is inserted into the ear canal 113 and holds the attachment portion 4 at a predetermined position of the ear canal 113, the wearing portion 6 which is positioned on the opposite side of the attachment portion 4 with the holding portion 5 interposed therebetween and is formed in a shape having a curved portion, and the outer arrangement portion 7 which is positioned on the opposite side of the holding portion 5 with the wearing portion 6 interposed therebetween and at least part of which is positioned outside of the auricle 101. In addition, in the sound pickup device 1, the attachment portion 4, the holding portion 5, the wearing portion 6, and the outer arrangement portion 7 each contain a linear material and are formed into a predetermined shape, the wearing portion 6 is inserted into the cavum conchae 114, and at least part thereof is engaged with the auricle 101.

Therefore, since the attachment portion 4, the holding portion 5, and the wearing portion 6 contain the linear material, the attachment portion 4, the holding portion 5, and the wearing portion 6 do not block the ear canal 113 and the sound pickup device 1 has an acoustic transmission property. In a state where the sound pickup unit 2, the attachment portion 4, and the holding portion 5 are inserted into the ear canal 113, the wearing portion 6 is inserted into the cavum conchae 114 and engaged with the auricle 101. As a result, propagation of a sound wave toward the sound pickup unit 2 is hardly inhibited, and the wearing portion 6 formed in the shape having the curved portion is engaged with the auricle 101, so that it is possible to satisfactorily input a sound to the sound pickup unit 2 and ensure a favorable wearing state to the ear 100.

In addition, since the attachment portion 4 having a constant length and the wearing portion 6 continuous to the holding portion 5 are held in the cavum conchae 114, even in a case where the sound pickup device 1 is repeatedly worn on the ear 100, the position of the sound pickup unit 2 held by the attachment portion 4 with respect to the eardrum 116 is always constant, high reproducibility of the position of the sound pickup unit 2 with respect to the eardrum 116 is ensured, and reliability of the measured value can be improved. Note that, although the sound pickup device 1 is worn on each of the left ear 100 and the right ear 100, the positions of the sound pickup units 2 and 2 with respect to the eardrums 116 and 116 can be made constant at all times also in the left and right ears 100 and 100.

Furthermore, since the attachment portion 4, the holding portion 5, the wearing portion 6, and the outer arrangement portion 7 each contain the linear material and are formed into the predetermined shape, the thickness of each of the attachment portion 4, the holding portion 5, and the wearing portion 6 is small and the volume thereof is small. Thus, reflection or diffraction of a sound wave by the attachment portion 4, the holding portion 5, the wearing portion 6, and the outer arrangement portion 7 hardly occurs, and a favorable input state of a sound to the sound pickup unit 2 can be ensured.

Furthermore, the device main body 3 is constituted by the attachment portion 4, the holding portion 5, the wearing portion 6, and the outer arrangement portion 7, and the device main body 3 contains one continuous linear material.

Therefore, since the device main body 3 contains one material, the sound pickup device 1 can be easily formed while the manufacturing cost is reduced.

Furthermore, since the attachment portion 4 is formed in the coil shape, the volume of the attachment portion 4 is small, and reflection or diffraction of a sound wave by the attachment portion 4 hardly occurs, so that a favorable input state of a sound to the sound pickup unit 2 can be ensured.

Additionally, since the holding portion 5, in addition to the attachment portion 4, is also formed in the coil shape, the volume of each of the attachment portion 4 and the holding portion 5 is small, and reflection or diffraction of a sound wave by the attachment portion 4 and the holding portion 5 more hardly occurs, so that a more favorable input state of a sound to the sound pickup unit 2 can be ensured.

In particular, the attachment portion 4 and the holding portion 5 to be inserted into the ear canal 113 are formed in the coil shape and an outer peripheral surface in a cross-sectional shape is formed in a curved surface shape, whereby it is possible to prevent the wall surface 113b from being scratched even when the attachment portion 4 or the holding portion 5 comes into contact with the wall surface 113b of the ear canal 113.

### <Another Example of Sound Pickup Device>

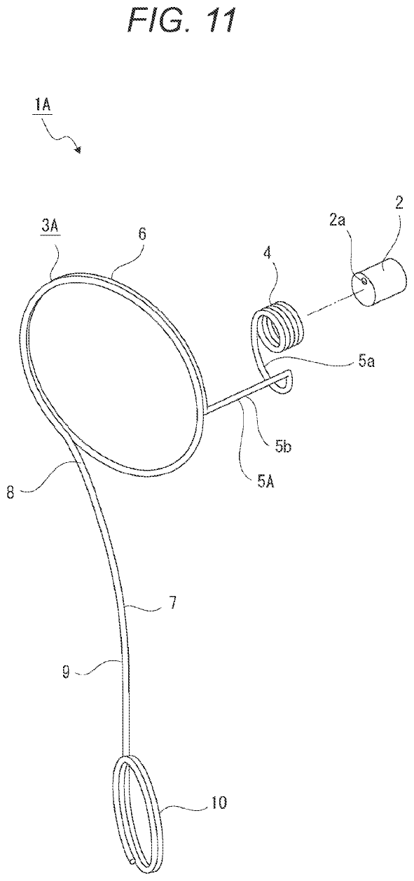

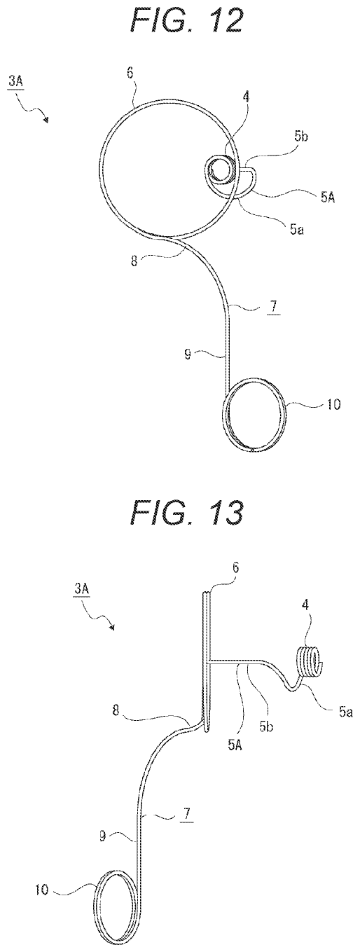

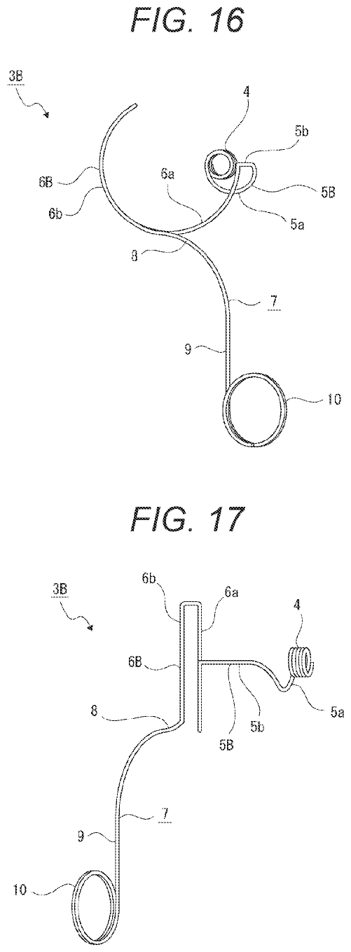

Hereinafter, another example of a sound pickup device will be described (see FIGS. 11 to 20).

First, a sound pickup device 1A according to a first different example will be described (see FIGS. 11 to 13).

Note that the sound pickup device 1A described below is different from the sound pickup device 1 described above only in that the holding portion in the device main body has a different shape. Therefore, only portions different from the sound pickup device 1 will be described in detail, and the other portions will be denoted by the same reference numerals as those assigned to similar portions in the sound pickup device 1, and description thereof will be omitted.

The sound pickup device 1A includes the sound pickup unit 2 and a device main body 3A (see FIG. 11).

In the device main body 3A, the attachment portion 4, a holding portion 5A, the wearing portion 6, and the outer arrangement portion 7 are sequentially and continuously formed, and the attachment portion 4, the holding portion 5A, the wearing portion 6, and the outer arrangement portion 7 each contain, for example, a linear (wire-like) metal material and are formed into a predetermined shape (see FIGS. 11 to 14).

In the device main body 3A, for example, the attachment portion 4, the holding portion 5A, the wearing portion 6, and the outer arrangement portion 7 are integrally formed. The device main body 3A has a cross-sectional shape contains, for example, a circular metal material.

The holding portion 5A includes a curved connecting portion 5a continuous to one end of the attachment portion 4 and a linear portion 5b extending in the axial direction of the attachment portion 4, and both ends of the linear portion 5b are continuous to one end of the connecting portion 5a and one end of the wearing portion 6, respectively. The linear portion 5b of the holding portion 5A is positioned to be shifted in a direction orthogonal to the axial direction with respect to the central axis P1 of the attachment portion 4.

In a case where the sound pickup device 1A is used by being worn on the ear 100, there is a case where an earphone is also used by being worn on the ear 100.

When the earphone is worn on the ear 100, for example, a sound binaurally recorded by the sound pickup unit 2 is heard by the earphone, whereby it is possible to reproduce realistic feeling as if the user were present at the scene of recording. Furthermore, it is also possible to reproduce the realistic feeling by obtaining a head-related transfer function on the basis of a binaural recorded sound signal, adjusting the sound signal on the basis of the head-related transfer function, virtually localizing a sound image, and outputting the sound image from the earphone.

As described above, in the sound pickup device 1A, since part of the holding portion 5A is provided as the linear portion 5b, an occupied area of the holding portion 5A is small between the wearing portion 6 and the attachment portion 4, and a space between the wearing portion 6 and the attachment portion 4 is increased.

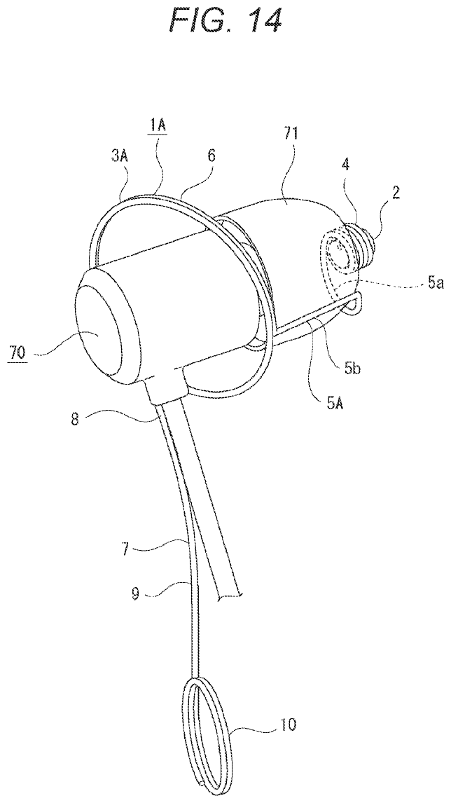

Therefore, in the state where the sound pickup device 1A is worn on the ear 100, for example, a canal-type earphone 70 can be worn on the ear 100 and used (see FIG. 14). The earphone 70 is used in a state where an earpiece 71 is inserted into the wearing portion 6 in the state where the sound pickup device 1A is worn on the ear 100, and at least a distal end portion of the earpiece 71 is inserted into the ear canal 113.

As described above, in the sound pickup device 1A, part of the holding portion 5A is formed linearly, and the occupied area of the holding portion 5A is small between the wearing portion 6 and the attachment portion 4, and the space between the wearing portion 6 and the attachment portion 4 is increased. Therefore, when the earpiece 71 of the earphone 70 is inserted, the earpiece 71 hardly interferes with the holding portion 5A, and both the sound pickup device 1A and the earphone 70 can be worn on the ear 100 in a stable state.

Additionally, in the sound pickup device 1A, since the holding portion 5A is constituted by the curved connecting portion 5a and the linear portion 5b, the weight of the device main body 3A is reduced, and it is possible for the user to obtain a good wearing feeling on the ear 100.

Note that, in a state where the sound pickup device 1A is worn on the ear 100, it is desirable that the linear portion 5b of the holding portion 5A be in contact with a wall surface 113b forming the ear canal 113. The sound pickup device 1A is worn on the ear 100 in a state where the linear portion 5b is in contact with the wall surface 113b in this manner, whereby a stable wearing state of the sound pickup device 1A on the ear 100 can be ensured.

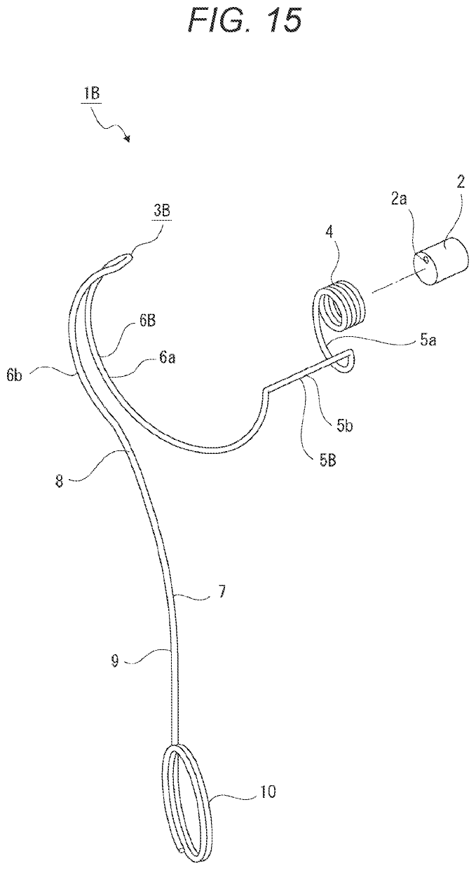

Next, a sound pickup device 1B according to a second different example will be described (see FIGS. 15 to 20).

Note that the sound pickup device 1B described below is different from the sound pickup device 1 described above only in that the holding portion and the wearing portion in the device main body has a different shape. Therefore, only portions different from the sound pickup device 1 will be described in detail, and the other portions will be denoted by the same reference numerals as those assigned to similar portions in the sound pickup device 1, and description thereof will be omitted.

The sound pickup device 1B includes the sound pickup unit 2 and a device main body 3B (see FIG. 15).

In the device main body 3B, the attachment portion 4, a holding portion 5B, a wearing portion 6B, and the outer arrangement portion 7 are sequentially and continuously formed, and the attachment portion 4, the holding portion 5B, the wearing portion 6B, and the outer arrangement portion 7 each contain, for example, a linear (wire-like) metal material and are formed into a predetermined shape (see FIGS. 15 to 17).

In the device main body 3B, for example, the attachment portion 4, the holding portion 5B, the wearing portion 6B, and the outer arrangement portion 7 are integrally formed. The device main body 3B has a cross-sectional shape contains, for example, a circular metal material.

The holding portion 5B includes the curved connecting portion 5a continuous to one end of the attachment portion 4 and the linear portion 5b extending in the axial direction of the attachment portion 4, and both ends of the linear portion 5b are continuous to one end of the connecting portion 5a and one end of the wearing portion 6B, respectively. The linear portion 5b of the holding portion 5B is positioned to be shifted in a direction orthogonal to the axial direction with respect to the central axis P1 of the attachment portion 4.

The wearing portion 6B has an arc-shaped first portion 6a and a second portion 6b which have different lengths, and the first portion 6a and the second portion 6b are folded back at an intermediate portion so as to be positioned with a constant interval therebetween in the axial direction. Both the first portion 6a and the second portion 6b have the same arc diameter, and are at positions overlapping with each other when viewed from the axial direction.

In the wearing portion 6B, for example, the length of the first portion 6a is longer than the length of the second portion 6b, and the first portion 6a is desirably formed in an arc shape having a central angle of 240 degrees or more.

In a case where the sound pickup device 1B is used by being worn on the ear 100, the earphone may also be used by being worn on the ear 100.

As described above, in the sound pickup device 1B, since part of the holding portion 5B is provided as the linear portion 5b, an occupied area of the holding portion 5B is small between the wearing portion 6B and the attachment portion 4, and a space between the wearing portion 6B and the attachment portion 4 is increased.

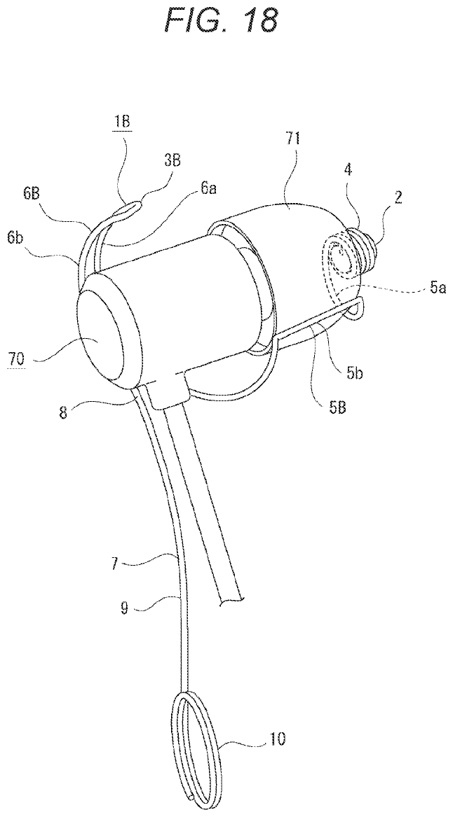

Therefore, in a state where the sound pickup device 1B is worn on the ear 100, for example, a canal-type earphone 70 can be worn on the ear 100 and used (see FIG. 18). The earphone 70 is used in a state where the earpiece 71 is inserted into the wearing portion 6 in a state where the sound pickup device 1B is worn on the ear 100, and at least a distal end portion of the earpiece 71 is inserted into the ear canal 113.

Additionally, since the wearing portion 6B in the sound pickup device 1B is formed in an arc shape, the wearing portion 6B has an open shape.

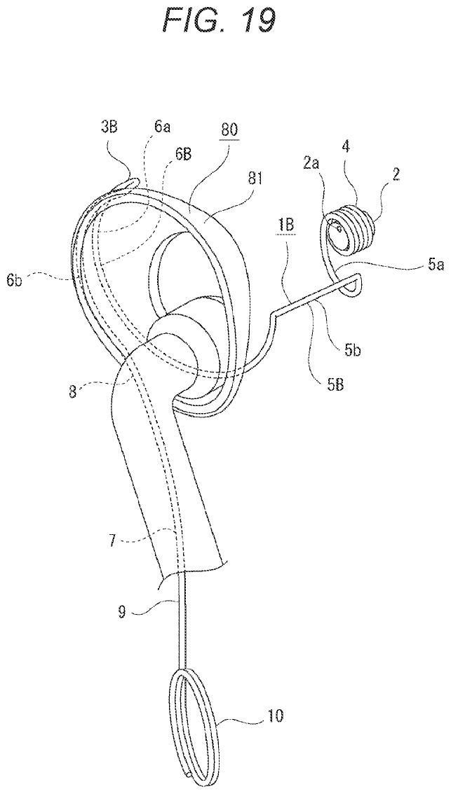

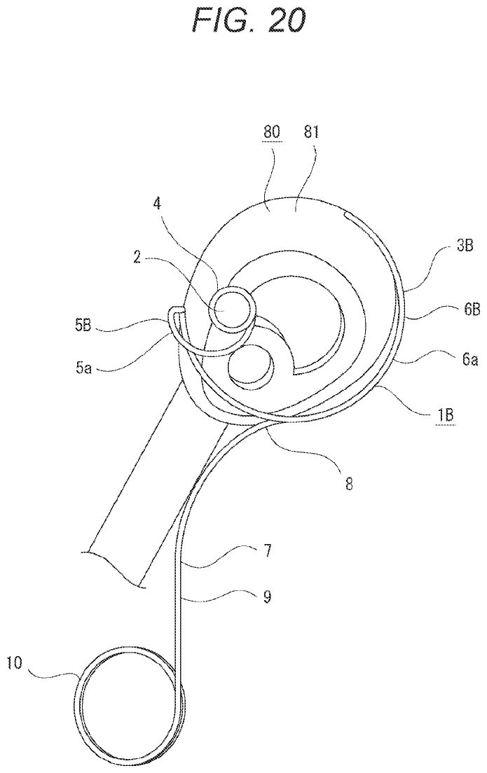

Therefore, in a state where the sound pickup device 1B is worn on the ear 100, for example, an inner ear-type earphone 80 can be worn on the ear 100 and used (see FIGS. 19 and 20). The earphone 80 is used in a state where part of a main body portion 81 is inserted into the wearing portion 6B in a state where the sound pickup device 1B is worn on the ear 100.

As described above, in the sound pickup device 1B, part of the holding portion 5B is formed linearly, and the occupied area of the holding portion 5B is small between the wearing portion 6B and the attachment portion 4, and the space between the wearing portion 6B and the attachment portion 4 is increased. Therefore, when the earpiece 71 of the earphone 70 is inserted, the earpiece 71 hardly interferes with the holding portion 5B, and both the sound pickup device 1B and the earphone 70 can be worn on the ear 100 in a stable state.

Furthermore, in the sound pickup device 1B, since the wearing portion 6B is formed in an arc shape and the wearing portion 6B is formed in an open shape, the earphone 80 hardly interferes with the wearing portion 6B in a state where the earphone 80 is worn on the ear 100, and both the sound pickup device 1B and the earphone 80 can be worn on the ear 100 in a stable state.

Furthermore, in the sound pickup device 1B, since the holding portion 5B is constituted by the curved connecting portion 5a and the linear portion 5b, the weight of the device main body 3B is reduced, and it is possible for the user to obtain favorable wearing feeling on the ear 100.

Note that, in the state where the sound pickup device 1B is worn on the ear 100, it is desirable that the linear portion 5b of the holding portion 5B be in contact with the wall surface 113b forming the ear canal 113. The sound pickup device 1B is worn on the ear 100 in the state where the linear portion 5b is in contact with the wall surface 113b in this manner, whereby a stable wearing state of the sound pickup device 1B on the ear 100 can be ensured.

### Others

Next, other configurations of the sound pickup devices 1, 1A, and 1B will be described.

The sound pickup unit 2 can be made wireless. In this case, for example, a module for wireless communication is mounted on the outer arrangement portion 7, and the module and the sound pickup unit 2 are connected by a signal line. A battery is built in the module. A sound input to the sound pickup unit 2 through wireless communication is transmitted as a sound signal to the module via the signal line, and is wirelessly transmitted from the module to another device such as a measuring instrument.

Making transmission wireless in this manner eliminates the need for a connection cord for connecting the measuring instrument or the like to the sound pickup unit 2, and can thereby simplify a structure.

Furthermore, the sound pickup devices 1, 1A, and 1B may be provided with an acoustic output unit such as a speaker in addition to the sound pickup unit 2. In this case, the sound pickup devices 1, 1A, and 1B may come with a noise canceling function for outputting an antiphase sound signal with respect to a surrounding sound signal (noise) input to the sound pickup unit 2 to make noise difficult to be heard.

Furthermore, for example, the attachment portion 4 and the holding portions 5, 5A, and 5B may be attached to the acoustic output unit such as an ear hole open type earphone or the acoustic output unit such as an earphone having an ear cuff, whereby a device having both the sound pickup unit 2 and the acoustic output unit may be configured. Furthermore, by attaching, in addition to the sound pickup unit 2, a balanced armature type acoustic output unit to the attachment portion 4, a device including both the sound pickup unit 2 and the acoustic output unit can be configured.

Furthermore, a sensor may be attached to the sound pickup devices 1, 1A, and 1B. It is desirable that the sensor be attached to, for example, the attachment portion 4 or the holding portions 5, 5A, and 5B inserted into the ear canal 113. As the sensor, for example, a sensor for distance measurement, a contact type sensor, or the like is used. Alternatively, a camera may be provided instead of the sensor.

For example, by detecting the wearing state of the sound pickup device 1, 1A, or 1B on the ear 100 or the position of the sound pickup unit 2 with respect to the ear canal 113 by the sensor or the camera, it is possible to hold the sound pickup unit 2 at an appropriate position and to ensure high reproducibility at the time of each measurement regarding the position of the sound pickup unit 2. Furthermore, the positions of the sound pickup units 2 and 2 can be made to coincide with the respective ear canals 113 and 113 in the left and right ears 100 and 100.

In addition, information at the time of measurement may be detected by a sensor. For example, vital signs such as a heart rate, pulse rate, respiration, blood pressure, and body temperature of the subject at the time of measurement, and weather information such as a temperature and a humidity may be detected. Furthermore, the inclination, inclination direction, and the like of the head 200 of the subject may be detected using an acceleration sensor or the like.

Furthermore, for example, an actuator using a micromachine technology may be attached to the sound pickup devices 1, 1A, and 1B. For example, the insertion of the attachment portion 4 and the holding portions 5, 5A, and 5B into the ear canal 113, the control of the position of the sound pickup unit 2 in the ear canal 113, and the like can be performed by the actuator. Furthermore, the sound pickup unit 2 can be positioned at an appropriate position in the ear canal 113 by operation of the actuator on the basis of the information detected by the sensor.

Furthermore, as the sound pickup unit 2, for example, a micro electro mechanical systems (MEMS) microphone or the like using a fine processing technique may be used.

### Present Technology

The present technology can be configured as follows.

(1)

A sound pickup device including:
a sound pickup unit to which a sound is input;
an attachment portion to which the sound pickup unit is attached and which is inserted into an ear canal;
a holding portion that is inserted into the ear canal and holds the attachment portion at a predetermined position of the ear canal;
a wearing portion positioned on an opposite side of the attachment portion with the holding portion interposed therebetween and formed in a shape having a curved portion; and
an outer arrangement portion positioned on an opposite side of the holding portion with the wearing portion interposed therebetween and at least part of the outer arrangement portion positioned on an outer side of an auricle, in which
the attachment portion, the holding portion, the wearing portion, and the outer arrangement portion each contain a linear material and are formed into a predetermined shape, and
the wearing portion is inserted into a cavum conchae and at least part of the wearing portion is engaged with the auricle.
   (2)

The sound pickup device according to (1), in which
a device main body is constituted by the attachment portion, the holding portion, the wearing portion, and the outer arrangement portion, and
the device main body contains one continuous linear material.
   (3)

The sound pickup device according to (1) or (2), in which
an end portion of the outer arrangement portion positioned on an opposite side of the wearing portion is provided as a terminal portion, and
the terminal portion is formed in an annular shape.
   (4)

The sound pickup device according to any one of (1) to (3), in which
an end portion of the outer arrangement portion on the wearing portion side is provided as a base end portion having a curved shape, and
the base end portion is in contact with the auricle.
   (5)

The sound pickup device according to any one of (1) to (4), in which
a connection cord configured to output at least a signal is connected to the sound pickup unit, and
the connection cord is wound around the outer arrangement portion.
   (6)

The sound pickup device according to any one of (1) to (5), in which
the wearing portion is formed in a circular shape.
   (7)

The sound pickup device according to any one of (1) to (5), in which
the wearing portion is formed in an arc shape.
   (8)

The sound pickup device according to any one of (1) to (6), in which
the holding portion is formed in a coil shape.
   (9)

The sound pickup device according to (8), in which
the holding portion is brought into contact with a wall surface forming the ear canal.
   (10)

The sound pickup device according to any one of (1) to (7), in which
at least part of the holding portion is formed linearly.
   (11)

The sound pickup device according to any one of (1) to (10), in which
the attachment portion is formed in a coil shape.
   (12)

The sound pickup device according to any one of (1) to (11), in which
the sound pickup unit is positioned inside the attachment portion.
   (13)

The sound pickup device according to any one of (1) to (12), in which
the sound pickup unit is detachably attached to the attachment portion.
   (14)

The sound pickup device according to any one of (1) to (13), in which
the sound pickup unit is positioned in a state where a sound input hole is opened to an entrance side of the ear canal.

### Supplementary Note

The technology disclosed in the present specification has been described above in detail with reference to the specific embodiments. However, it is obvious that those skilled in the art can modify or substitute the above-mentioned embodiments without departing from the gist of the technology disclosed in the present specification.

The sound pickup device to which the technology disclosed in the present specification is applied is used by being worn on the ear, but has a significant feature in that it is the “ear hole open type” and also has a significant feature in that the wearing portion having the curved portion is engaged with the auricle and worn on the ear.

Therefore, the sound pickup device to which the technology disclosed in the present specification is applied can perform precise binaural recording in consideration of the influence of diffraction and reflection on the inner wall of the ear canal and reflection from the eardrum, and obtain a highly accurate head-related transfer function representing a change in sound in consideration of the shape of the ear canal and the influence of the reflected sound from the eardrum while implementing listening characteristics of an ambient sound equivalent to those in a non-wearing state even in the wearing state. In addition, stable and favorable wearability on the ear can be ensured.

### REFERENCE SIGNS LIST

100 Ear
101 Auricle
113 Ear canal
113b Wall surface
114 Cavum conchae
115 Intertragic notch
1 Sound pickup device
2 Sound pickup unit
2a Sound input hole
3 Device main body
4 Attachment portion
5 Holding portion
6 Wearing portion
7 Outer arrangement portion
8 Base end portion
10 Terminal portion
11 Connection code
1A Sound pickup device
3A Device main body
5A Holding portion
1B Sound pickup device
3B Device main body
5B Holding portion
6B Wearing portion

1. A sound pickup device comprising:
a sound pickup unit to which a sound is input;
an attachment portion to which the sound pickup unit is attached and which is inserted into an ear canal;
a holding portion that is inserted into the ear canal and holds the attachment portion at a predetermined position of the ear canal;
a wearing portion positioned on an opposite side of the attachment portion with the holding portion interposed therebetween and formed in a shape having a curved portion; and
an outer arrangement portion positioned on an opposite side of the holding portion with the wearing portion interposed therebetween and at least part of the outer arrangement portion positioned on an outer side of an auricle, wherein
the attachment portion, the holding portion, the wearing portion, and the outer arrangement portion each contain a linear material and are formed into a predetermined shape, and
the wearing portion is inserted into a cavum conchae and at least part of the wearing portion is engaged with the auricle.

2. The sound pickup device according to claim 1, wherein
a device main body is constituted by the attachment portion, the holding portion, the wearing portion, and the outer arrangement portion, and
the device main body contains one continuous linear material.

3. The sound pickup device according to claim 1, wherein
an end portion of the outer arrangement portion positioned on an opposite side of the wearing portion is provided as a terminal portion, and
the terminal portion is formed in an annular shape.

4. The sound pickup device according to claim 1, wherein
an end portion of the outer arrangement portion on the wearing portion side is provided as a base end portion having a curved shape, and
the base end portion is in contact with the auricle.

5. The sound pickup device according to claim 1, wherein
a connection cord configured to output at least a signal is connected to the sound pickup unit, and
the connection cord is wound around the outer arrangement portion.

6. The sound pickup device according to claim 1, wherein
the wearing portion is formed in a circular shape.

7. The sound pickup device according to claim 1, wherein
the wearing portion is formed in an arc shape.

8. The sound pickup device according to claim 1, wherein
the holding portion is formed in a coil shape.

9. The sound pickup device according to claim 8, wherein
the holding portion is brought into contact with a wall surface forming the ear canal.

10. The sound pickup device according to claim 1, wherein
at least part of the holding portion is formed linearly.

11. The sound pickup device according to claim 1, wherein
the attachment portion is formed in a coil shape.

12. The sound pickup device according to claim 1, wherein
the sound pickup unit is positioned inside the attachment portion.

13. The sound pickup device according to claim 1, wherein
the sound pickup unit is detachably attached to the attachment portion.

14. The sound pickup device according to claim 1, wherein
the sound pickup unit is positioned in a state where a sound input hole is opened to an entrance side of the ear canal.
